(19) United States
(12) Patent Application Publication
(10) Pub. No.: US 2011/0006505 A1
(43) Pub. Date: Jan. 13, 2011

(54) Roller Apparatus For Generator, Pump and The Like

(76) Inventor: Wen Chang Wang, Rende Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/498,546

(22) Filed: Jul. 7, 2009

(51) Int. Cl. B62B 3/00

(52) U.S. Cl. 280/651

(57) ABSTRACT

A roller apparatus for generator, pump and the like is disclosed, where the generator, pump or the like is lodged in a frame, and the roller apparatus is set up at the bottom of the frame, comprising: a plurality of rollers, for rolling along the ground; and a plurality of link units, for linking each roller to the frame, where each link unit is provided with: a brace, obliquely set up at each bottom corner of the frame with a screw hole; a wheel carrier, having its bottom portion join fixedly to the roller and its top portion fixed by a fastener with a shaft portion, for oscillating up and down, and having a screw hole at its middle; and a fixing article, joining the wheel carrier. Through joining the wheel carrier with the frame together by the fixing article, the rollers is ready to unfold for rolling on the ground, or through joining the wheel carrier with the brace together by the fixing article, the rollers is ready to fold aside from the ground, to achieve simplicity in structure and handiness in manipulation.

### BACKGROUND OF THE INVENTION

1. Field of the Invention

This invention relates generally to roller apparatus for generator, pump and the like and more particularly to one that is simple in structure and easy in handling the folding and unfolding.

2. Description of the Prior Art

Prior art generators and pumps are mostly immobile types. Due to the vast volume and hefty weight, it is time consuming to move generators and pumps. And wheels are always added to form a mobile type of generator (or pump). As shown in FIG. 6, a generator 4 is lodged in a frame 40, where the frame 40 is provided with a wheel 41 at the bottom of each corner, which is available to roll along the ground. The wheel 41 is axially connected to the bottom of a lifting shaft 42, and the lifting shaft 42 wears a spring 43 and both together are placed in a sleeve 44, where the sleeve 44 is fixedly joined to the frame 40 and is penetrated by a bolt 45 which props against a locating slot 46 or a plane 47, enabling the wheel 41 to unfold to the ground or fold away from the ground, shown in FIGS. 7 & 8.

The aforementioned prior art examples have features both in forming immobile type when folding wheels, or forming mobile type when unfolding the wheels. However, the following drawbacks still exist, which have to be improved sooner or later:
1. The structures thereof are complicated.
2. It is time consuming in operating the folding and the unfolding.
3. Fastening merely by a single bolt 45 is prone to break.
4. Once the wheels are installed to the sealed type of generator, an outer cover is needed to dismount, which is gravely troublesome.

In the light of the aforementioned drawbacks of the prior art, this inventor hence conceived the idea for the advanced improvement, and eventually the endeavors gave birth to this invention.

### SUMMARY OF THE INVENTION

The objective of this invention is to provide a roller apparatus for generator, pump and the like that is simple in structure and easy in operating.

To achieve the aforesaid objects, the generator, pump or the like used for this invention is placed in a frame, and the roller apparatus is set up at the bottom of the frame, comprising: multiple rollers, for rolling along the ground; and multiple link units, for linking each roller to the frame, where each link unit is provided with: a brace, obliquely set up at each bottom corner of the frame with a screw hole; a wheel carrier, having its bottom portion join fixedly to the roller, having its top portion fixed by a fastener with shaft, for oscillating up and down, and having a screw hole at its middle; and a fixing article, joining the wheel carrier; through joining the wheel carrier and the frame together by the fixing article, the rollers are ready to unfold for rolling on the ground, or through joining the wheel carrier and the brace together by the fixing article, the rollers are ready to fold aside from the ground, to achieve simplicity in structure and handiness in manipulation.

### BRIEF DESCRIPTION OF THE DRAWINGS

FIG. 1 is a three-dimensional diagram of this invention;

FIG. 2 is a partially exploded diagram of this invention;

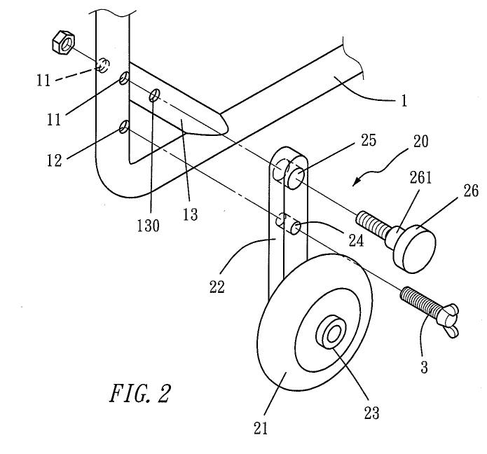

FIG. 3 is a schematic diagram of the unfolding for moving of this invention;

FIG. 4 is a schematic enlarged sectional diagram of the unfolding for moving of this invention;

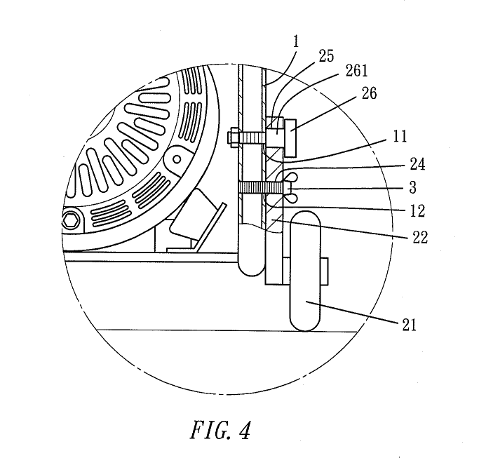

FIG. 5 is a schematic diagram of the folding for immobility of this invention;

FIG. 6 is a three-dimensional exploded diagram of the roller apparatus of a prior art generator;

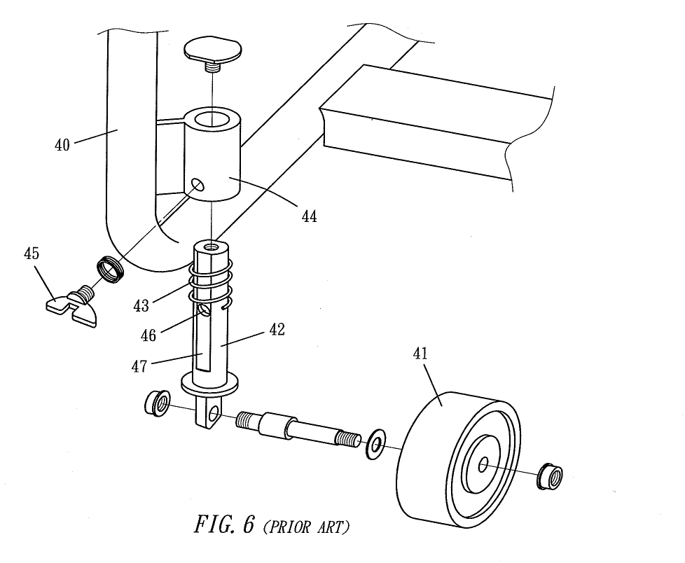

FIG. 7 is a schematic diagram of the unfolding to the ground of the roller apparatus of a prior art generator; and

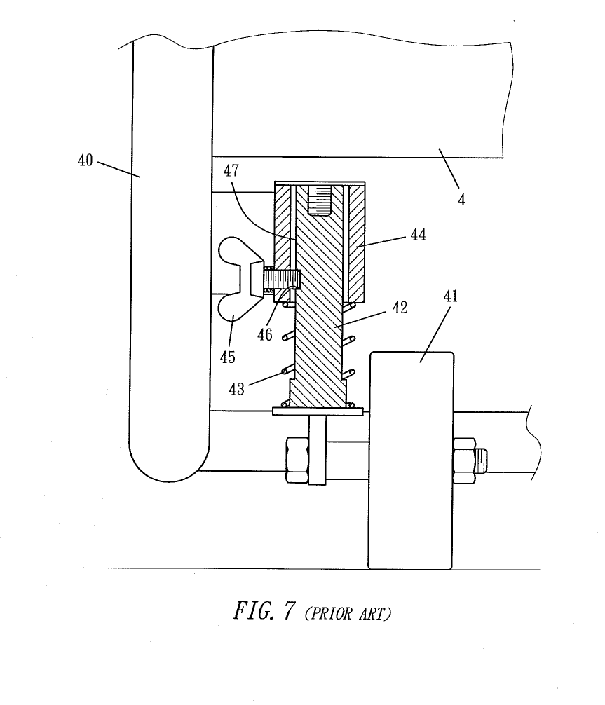

FIG. 8 is a schematic diagram of the folding aside from the ground of the roller apparatus of a prior art generator.

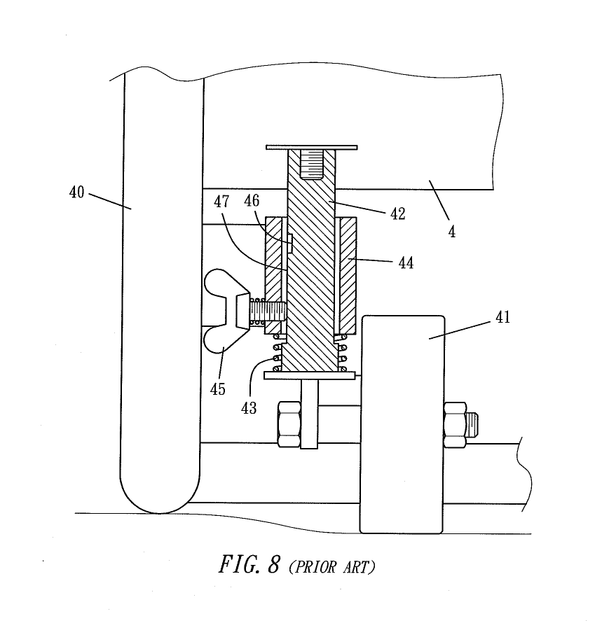

### DETAILED DESCRIPTION OF THE INVENTION

The structural traits and the function of the present invention are detailed described with reference to the following preferred embodiment and the accompanying drawings, which would give a thorough comprehension on the present invention.

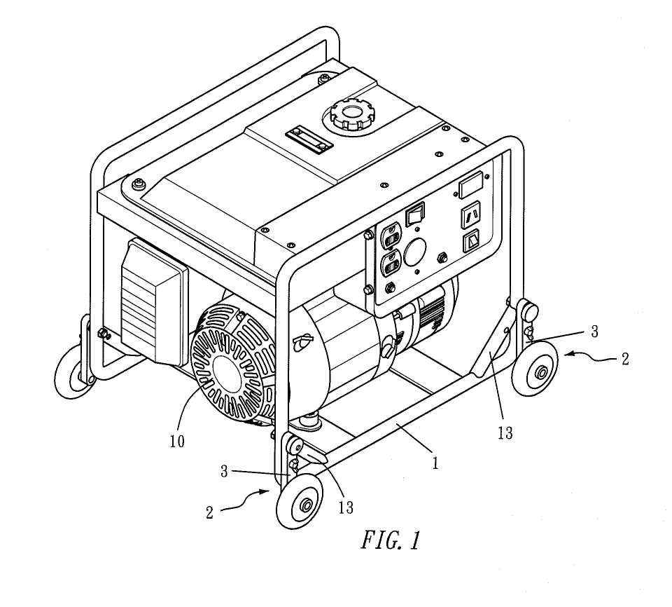

Referring to FIGS. 1 & 2, a generator 10 (or pump) is lodged in a C-shaped frame 1, and roller apparatus 2 is set up at the bottom of the frame 1, which comprises plural (can be four) rollers 21 (wheels) rolling along the ground, and plural (can be four) link units 20 to join each roller 21 to the frame 1. For easier illustration, one end of the frame 1 and a single link unit 20 is exemplified.

The frame 1, having a through hole 11 and a screw hole 12 at the top and bottom of its bottom portion, is provided with a oblique brace 13 at each bottom corner, where the brace 13 has its both ends join fixedly to the frame 1 and a screw hole 130 in its middle.

The link unit 20, aside from the aforesaid brace 13, comprises: a wheel carrier 22, joining the roller 21 at its bottom through an axle 23, having a screw hole 24 in its middle, and having a through hole 25 at its top, which is penetrated by a fastener 26, and the fastener 26 further penetrates a through hole 11 of the frame 1. Through helical connection by the end thread of the fastener 26 and a bolt, the wheel carrier 22 is fastened to one side of the frame 1, where the portion that the fasten 26 penetrates the wheel carrier 22 is a shaft 261, which enables the wheel carrier 22 to swing up and down with respect to the fastener 26, the axle center.

The fixing article 3, possibly being a wing bolt, is helically connected to the screw holes 24, 12 of the wheel carrier 22 and the frame 1 respectively, where the fastener 26 and the fixing article 3 help to stabilize the roller 21 at up and down locations. And it may helically connect to the screw holes 24, 130 of the wheel carrier 22 and the brace 13 respectively, which can achieve the same top and down stabilization.

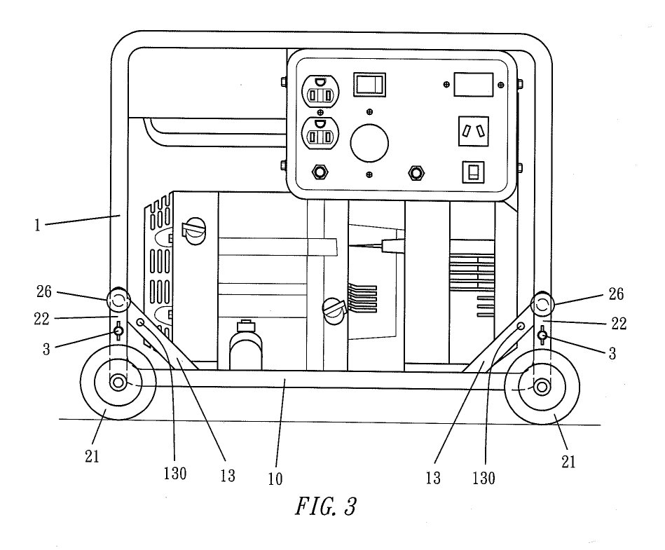

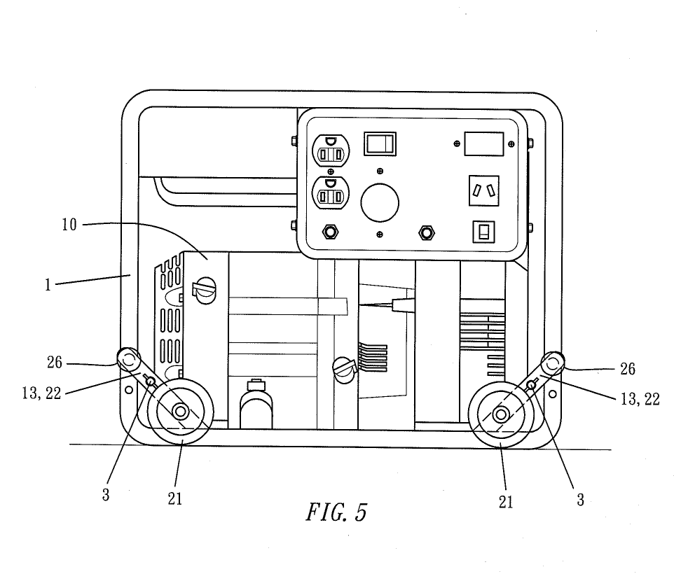

According to the aforesaid structure, as the generator 10 (or pump) demands a moving, the rollers 21 are unfolded to touch ground. At the moment, the wheel carrier 22 and the frame 1 are helically connected by the fixing article 3, shown in FIGS. 3 & 4. Once the generator 10 (or pump) is immobilized, the fixing article 3 is first being loosen, which departs from the frame 1 but still contacts helically with the wheel carrier 22, followed by an upward moving of the wheel carrier 22 (with the roller 21) with respect to the fastener 26, the rotating axis, and aiming at the brace 13. By helically joining the fixing article 3 and the brace 13, the roller 21 is ready for folding aside from the ground, shown in FIG. 5. On the other hand, as the generator 10 (or pump) is demanded for a moving again, the fixing article 3 is first being loosen, which departs from the brace 13 but still contacts helically with the wheel carrier 22, followed by an upward moving of the wheel carrier 22 with respect to the fastener 26, the rotating axis, and aiming at the frame 1. By helically joining the fixing article 3 and the frame 1, the roller 21 is ready for unfolding to touch the ground, returning to the state shown in FIGS. 3 & 4.

Accordingly, this invention has at least the following advantages and features, which is much creative than the prior art.
1.) It has a simple structure, merely comprising braces 13, wheel carriers 22, fasteners 26 and fixing articles 3.
2.) Easy in the operating. Only rotating the fixing article, with an up-down moving of the wheel carrier 22, the unfolding to the ground and the folding from the ground can be accomplished respectively.
3.) No tools needed during the operating, since the fixing article could be a wing bolt, which demands only hand operating.
4.) With dual bolts 26, 3 for the support of the fixing, it has better firmness.
5.) The roller apparatus can be mounted directly to the outer shell of the sealed type of the generator, freeing of tearing down the outer shell anymore.

The present invention is not only novel but creative, which is construed as fully in compliance with the requirements of invention patentability, thereby filing the present application herein subject to the patent law.

What is claimed is:

1. A roller apparatus for generator, pump and the like, where the generator, pump or the like is lodged in a frame, and the roller apparatus being set up at the bottom of the frame, comprising:
a.) a plurality of rollers, for rolling along the ground; and
b.) a plurality of link units, for linking each roller to the frame, where each link unit is provided with:
1.) a brace, obliquely set up at each bottom corner of the frame with a screw hole;
2.) a wheel carrier, having its bottom portion join fixedly to the roller and its top portion fixed by a fastener with a shaft portion, for oscillating up and down, and having a screw hole at its middle; and
3.) a fixing article, joining the wheel carrier.

2. Through joining the wheel carrier with the frame together by the fixing article, the rollers being ready to unfold for rolling on the ground, or through joining the wheel carrier with the brace together by the fixing article, the rollers being ready to fold aside from the ground, to achieve simplicity in structure and handiness in manipulation.
